(19) United States
(12) Patent Application Publication
(10) Pub. No.: US 2010/0095190 A1
(43) Pub. Date: Apr. 15, 2010

(54) STORAGE DEVICE AND DATA READING METHOD THEREOF

(75) Inventor: Hiroshi Kanaya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/562,699

(22) Filed: Sep. 18, 2009

(30) Foreign Application Priority Data
Oct. 10, 2008 (JP) 2008-263881

(51) Int. Cl. G06F 11/07

(52) U.S. Cl. 714/797; 714/E11.029

(57) ABSTRACT

According to one embodiment, a data reading method of a storage device for reading data from a storage module, includes: reading data from the storage module; detecting an error in the data; reading, when the error is detected, the data several times; storing each data read several times in a buffer; calculating correlation between the data stored in the buffer; selecting data stored in the buffer with strong correlation so as to exclude data with low correlation from the selection; performing majority decision on the selected data or averaging the selected data; and outputting a result of the majority decision or the averaging as read data.

### CROSS-REFERENCE TO RELATED APPLICATIONS

This application is based upon and claims the benefit of priority from Japanese Patent Application No. 2008-263881, filed Oct. 10, 2008, the entire contents of which are incorporated herein by reference.

### BACKGROUND

1. Field

One embodiment of the invention relates to a storage device and a data reading method of the storage device performing a retry sequence to reduce a read error.

2. Description of the Related Art

Various techniques have been employed to obtain accurate data from signals read out from recent storage devices, in accordance with an increase in a density of the storage devices. Such techniques that are used generally include error detection/correction processing and a retry sequence that retries data reading.

A disk storage device in particular causes the read error due to cross-talk, vibration, and the external magnetic field, because a track pitch of the disk storage medium is narrow. Therefore, a technique of reading data several times and judging the read data by majority logic is introduced to the retry processing to correct data (for example, see Japanese Patent Application Publication (KOKAI) No. 2007-200552).

FIG. 17 is an exemplary flowchart of conventional read processing using the majority logic. When the read error is detected, the read processing is started. Then, the number of reading n (n>1) is set, and a buffer number buff for storing the read data is initialized to “0” (S100). Next, the data is read from the storage medium (disk) and the read data is stored in an area indicated by the buffer number buff of a dynamic random access memory (DRAM) (S102).

Then, the buffer number buff is incremented by 1 (S104). It is determined from the buffer number buff whether the n-time reading is finished, and if not, the process goes back to S102 (S106). When the n-time reading is finished, the majority decision is performed on each bit value for n buffer data. Then, one read data is created, the created data is corrected by ECC correction, and the corrected data is output (S108).

The storage device is placed in various environments, such as under influence of vibration or electromagnetic field. Here, the external vibration is sensed when the magnetic disk storage device is placed near an audio device such as a speaker. Further, the electromagnetic field is sensed when the storage device is placed near a radio communication device such as a portable phone.

In such environments, a read error is likely to be caused in the magnetic disk by noise due to strong electromagnetic field or displacement of a head by external vibration. Likewise, the read error of multi-value data is likely to be caused in the storage device such as a flash memory by noise due to the strong electromagnetic field.

The conventional retry processing using the majority logic equivalently evaluates each read data. Therefore, the external vibration or the noise occurred in some frequency causes the degree of the error to vary. As a result, results of the majority decision may adversely be influenced and the capability of error correction may be deteriorated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a storage device according to a first embodiment of the invention;

FIG. 2 is an exemplary block diagram of a read circuit in the first embodiment;

FIG. 3 is an exemplary flowchart of read processing in the first embodiment;

FIG. 4 is an exemplary flowchart of the read processing in the first embodiment;

FIG. 5 is an exemplary flowchart of multiple retry processing in the first embodiment;

FIG. 6 is an exemplary data coincidence table of FIG. 5 in the first embodiment;

FIG. 7 is an exemplary explanatory diagram of summation in FIG. 5 in the first embodiment;

FIG. 8 is an exemplary explanatory diagram illustrating strongly-correlated buffer selection processing of FIG. 5 in the first embodiment;

FIG. 9 is an exemplary explanatory diagram illustrating a hypothetical data error ratio corresponded to retry number in the first embodiment;

FIG. 10 is an exemplary explanatory diagram illustrating a ratio of a correct data obtained using a conventional majority decision based on the condition illustrated FIG. 9 in the first embodiment;

FIG. 11 is an exemplary data coincidence table based on the condition illustrated in FIG. 9 in the first embodiment;

FIG. 12 is an exemplary explanatory diagram illustrating a sum of each buffer obtained from the data coincidence table of FIG. 11 in the first embodiment;

FIG. 13 is an exemplary explanatory diagram illustrating a ratio of a correct data based on the condition illustrated in FIG. 9 in the first embodiment;

FIG. 14 is an exemplary block diagram of a read circuit according to a second embodiment of the invention;

FIG. 15 is an exemplary flowchart of multiple retry processing in the second embodiment;

FIG. 16 is an exemplary correlation coefficient table of FIG. 15 in the second embodiment; and

FIG. 17 is an exemplary flowchart of a conventional data majority decision processing.

### DETAILED DESCRIPTION

Various embodiments according to the invention will be described hereinafter with reference to the accompanying drawings. In general, according to one embodiment of the invention, a data reading method of a storage device for reading data from a storage module, includes: reading data from the storage module; detecting an error in the data; reading, when the error is detected, the data several times; storing each data read several times in a buffer; calculating correlation between the data stored in the buffer; selecting data stored in the buffer with strong correlation so as to exclude data with low correlation from the selection; performing majority decision on the selected data or averaging the selected data; and outputting a result of the majority decision or the averaging as read data.

According to another embodiment of the invention, a storage device includes: a storage module; a reproduction circuit configured to reproduce data read from the storage module; an error detecting circuit configured to detect an error in the data output from the reproduction circuit; a buffer configured to store the output from the reproduction circuit; and a control circuit configured to read the data several times when the error is detected, store each data read several times in the buffer, calculate correlation between the data stored in the buffer, select data stored in the buffer with strong correlation so as to exclude data with low correlation from the selection, wherein the control circuit perform majority decision on the selected data or averaging the selected data, and output the result of the majority decision or the averaging to the error detecting circuit.

Hereinafter, a storage device, a read circuit according to a first embodiment, read processing according to the first embodiment, retry processing according to the first embodiment, a second embodiment, and other embodiments, are explained in this order.

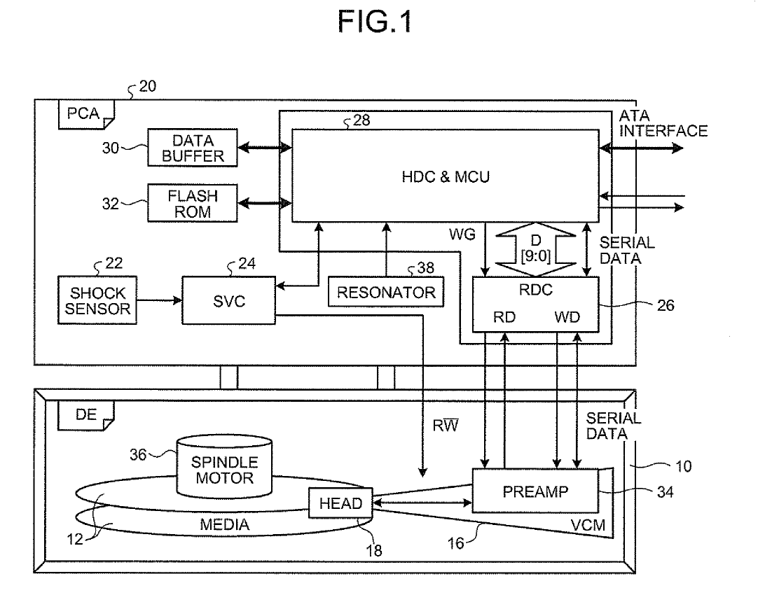

FIG. 1 is an exemplary block diagram of a storage device according to the first embodiment. Here, a magnetic disk device is explained as the storage device. As illustrated in FIG. 1, a magnetic disk 12 is provided with respect to a rotation shaft of a spindle motor 36. The spindle motor 36 rotates the magnetic disk 12. An actuator 16 includes a magnetic head 18 at a tip end thereof and moves the magnetic head 18 in the radial direction of the magnetic disk 12.

The actuator 16 includes a voice coil motor (VCM) having an arm rotating around the rotation shaft, a driving coil provided at the rear end of the arm, and a suspension (gimbal) provided at the tip end of the arm. The magnetic head 18 is provided at the suspension.

The actuator 16 is provided with a head IC (preamplifier) 34 including a write driver electrically connected to the magnetic head 18. The aforementioned configurations are held inside a disk enclosure 10.

The magnetic head 18 has a slider, a read element (MR element) and a write element. The magnetic head 18 is structured by stacking on the slider the read element including a magnetic resistor and stacking thereon the write element including a write coil. The core width of the magnetic resistor corresponds to the width of the track of the magnetic disk 12, and the width is for example, 0.3 to 0.4 micrometers.

A print circuit assembly (PCA) 20 is provided separately from the disk enclosure 10. The PCA 20 has a control circuit for the magnetic disk device mounted thereon. The control circuit has a servo controller 24, a read channel 26, a hard disk controller (HDC)/micro controller (MCU) 28, a data buffer 30 and a flash ROM 32.

Further, the PCA 20 has a shock sensor 22 for detecting shock given to the device. The servo controller 24 servo-controls the actuator 16 so that the magnetic head is positioned at a position instructed by the HDC/MCU 28.

The read channel 26 receives write (user) data and a write gate WG of the HDC/MCU 28, creates the write data WD containing synchronization mark and preamble, and outputs it to the magnetic head 18 via the head IC 34. In addition, the read channel 26 receives the read data RD from the magnetic head 18 via the head IC 34 and outputs it to the HDC/MCU 28.

The HDC/MCU 28 executes a program containing parameters stored in the flash ROM 32 by use of the data buffer 30.

The HDC/MCU 28 outputs a head positioning command to the servo controller 24, and the servo controller 24 follows the command to servo-control the actuator 16. As a result, the magnetic head 18 is positioned at a desired track position.

Further, the HDC/MCU 28 is connected to a host (not illustrated) via an interface such as an AT Attached (ATA) interface. In writing data, the HDC/MCU 28 transfers the write data to the read channel 26 and the transferred data is written by the magnetic head 18 through the head IC 34.

Likewise, in reading data, a read command is provided to the read channel 26, and the read channel 26 follows the read command to receive the read data RD from the magnetic head 18 via the head IC 34. Then, the read data is transferred to the HDC/MCU 28.

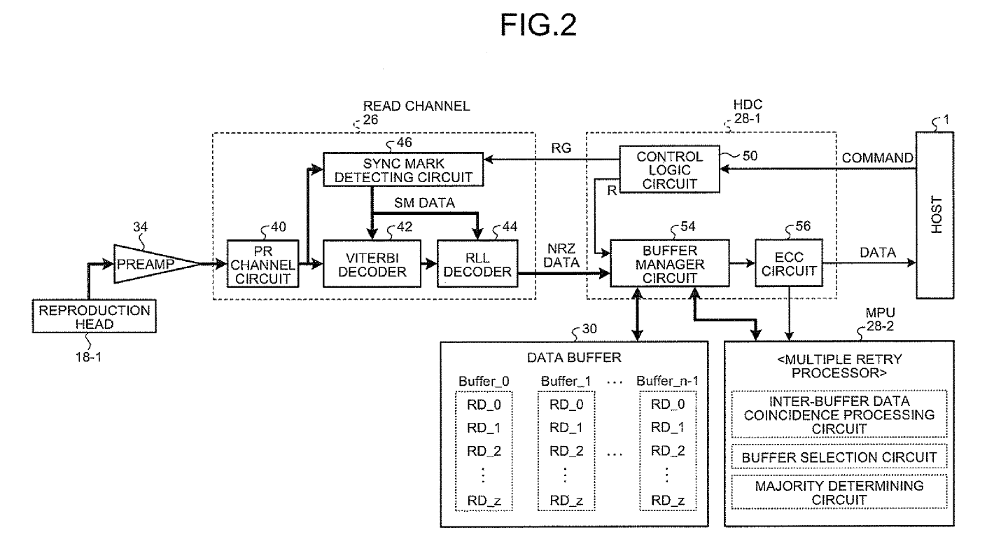

The HDC/MCU 28 executes the read processing including later-described retry processing. The read channel 26 and the HDC/MCU 28 are described in detail with reference to FIG. 2 and the like.

FIG. 2 is an exemplary block diagram of the read circuit according to the first embodiment, and illustrating an exemplary block diagram of the HDC/MCU 28 and the read channel 26 of FIG. 1.

As illustrated in FIG. 2, a read signal from a reproduction head (read element) 18-1 of the magnetic head 18 is input to a PR channel circuit 40 of the read channel 26 via the preamp (preamplifier) 34. The PR channel circuit 40 includes a variable gain amplifier (VGA), an asymmetry correction circuit (ASC), a continuous Time filter (CTF), an analogue/digital converter (ADC), a finite impulse response filter (FIR), an AGC circuit and the like.

The PR channel circuit 40 adjusts an amplitude and asymmetry of a read signal, performs waveform equalization at the control filter, performs the A/D conversion on the signal, and waveform-shapes a PR (partial response) signal at the FIR.

A synchronization (Sync) mark detecting circuit 46 detects a Sync mark SM of a predetermined pattern from the output of the PR channel circuit 40, and notifies a Viterbi decoder 42 and a run length limited (RLL) decoder 44 of the Sync mark detection signal.

The Viterbi decoder 42 receives the Sync mark detection signal and performs well-known maximum likelihood decoding on the output of FIR of the PR channel circuit 40 (user data after the Sync mark). That is, the Viterbi decoder 42 uses an anteroposterior relation of data, and selects a likelihood data row. The RLL decoder 44 decodes RLL coded data at writing side, and outputs NRZ data to a hard disk controller (hereinafter referred to as HDC) 28-1.

The HDC 28-1 includes a control logic circuit 50, a buffer manager circuit (DRAM controller) 54, and an ECC (error correcting code) circuit 56. The control logic circuit 50 receives a command from the host 1, and creates a read mode signal R and a read gate RG. The buffer manager circuit 54 read-write controls the data buffer 30. The ECC circuit 56 detects and corrects errors by ECC (error correcting code).

The NRZ data from the RLL decoder 44 is input to the buffer manager circuit 54. The buffer manager circuit 54 creates a buffer area in the data buffer 30 in response to an instruction from a micro controller (MPU) 28-2 described later, and stores the NRZ data (read data). In addition, the buffer manager circuit 54 follows the instruction of the MPU 28-2 to output to the ECC circuit 56 the data stored in the buffer or the data to which the processing using the majority decision is performed at the MPU 28-2.

The ECC circuit 56 performs error detection and correction on the input data. Then, when it is determined that the error correction cannot be performed, the ECC circuit 56 notifies the MPU 28-2 that the error correction cannot be performed. When it is determined that the error correction can be performed, the ECC circuit 56 performs error correction and transfers the corrected data to the host 1.

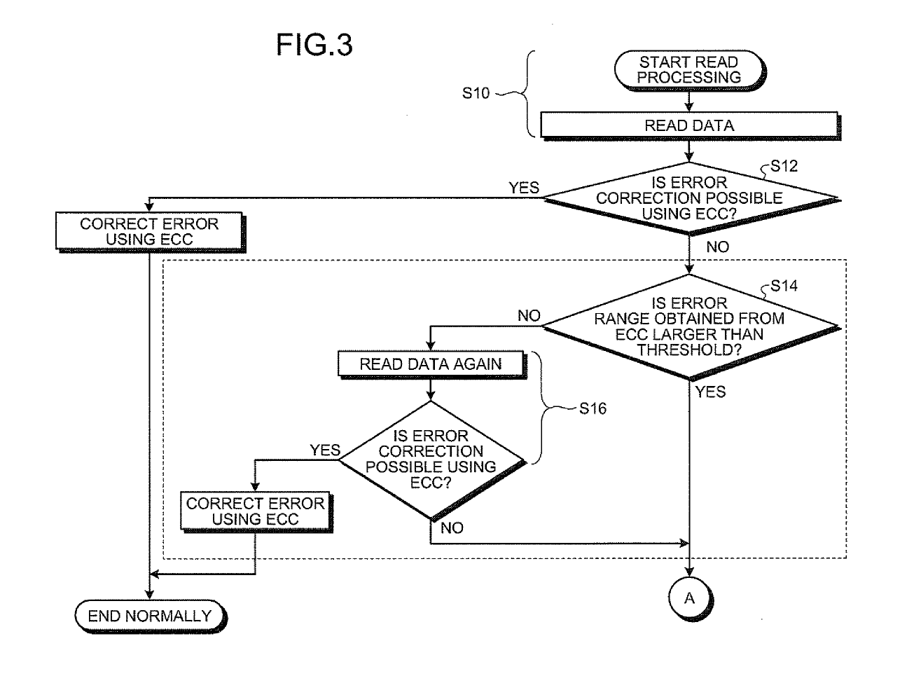

The MPU 28-2 executes read processing described later illustrated in FIG. 3 and controls the HDC 28-1. As described later, the MPU 28-2 detects the number of coincident data between buffers of the data buffer 30, selects a buffer based on the number of coincidence, and perform majority decision on the data of the selected buffer.

In the first embodiment, the MPU 28-2 retries reading data several times in the retry sequence to correct read errors, and stores the read data in the data buffers 30. Next, the MPU 28-2 determines correlation between the buffers storing the data resulting from the read retry, and uses the correlation in the majority decision. Then, the data error correction is performed by performing subsequent processing using certain buffers (retry data) out of the all buffers.

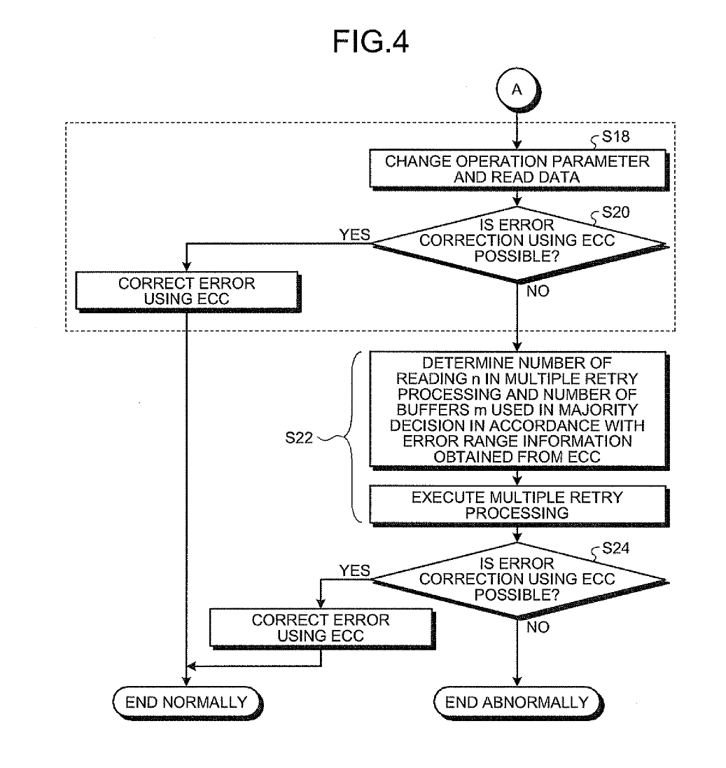

FIGS. 3 and 4 are flowcharts of the read processing according to the first embodiment. In the following, the read processing illustrated FIGS. 3 and 4 executed by the MPU 28-2 is described.

In S10, the MPU 28-2 analyzes a command from the host which the HDC 28-1 has received. Further, when the MPU 28-2 determines that the command is the read command, the MPU 28-2 starts the read processing, and reads a sector designated by an object logic block address (LBA) attached to the read command. That is, the MPU 28-2 instructs the HDC 28-1 to read the object sector, which then controls the VCM, positions the magnetic head 18 at the object track, and instructs the read channel 26 to process the signal from the reproduction head 18-1 via the preamplifier 34.

As described with reference to FIG. 2, the read channel 26 detects a Sync mark at the Sync mark detecting circuit 46 after waveform shaping at the PR channel circuit 40, thereby operates the Viterbi decoder 42 and the RLL decoder 44. The Viterbi decoder 42 performs maximum likelihood decoding, and the RLL decoder 44 performs RLL decoding on the decoded data. The RLL-decoded data (NRZ data) bypasses the buffer manager circuit 54 into the ECC circuit 56. Note that the MPU 28-2 instructs the buffer manager circuit 54 to be bypassed because the aforementioned processing is not the retry processing.

In S12, the ECC circuit 56 uses ECC of the NRZ data to perform error detection and correction. When error correction is possible using ECC, the ECC circuit 56 corrects the errors by ECC, notifies the MPU 28-2 that the error correction is possible, and outputs the corrected data to the host 1.

In S14, when ECC circuit 56 determines that the error correction using the ECC cannot be performed, the ECC circuit 56 notifies the MPU 28-2 that error correction is impossible. Accordingly, the MPU 28-2 performs retry processing. In the retry processing, the MPU 28-2 determines whether an error range of the error is larger than a predetermined threshold. When the error range is larger (wider) than the predetermined threshold, the processing goes to S18 in FIG. 4 since the error cannot be corrected by simple retry processing.

In S16, when the MPU 28-2 determines that the error range is not larger than the predetermined threshold, the MPU 28-2 performs the simple retry processing. That is, in the similar way as in S10, the MPU 28-2 instructs the HDC 28-1 to read the object sector. Then, in the similar way as in S12, the ECC circuit 56 corrects errors using ECC. Further, when the error correction using ECC is possible, the ECC circuit 56 notifies the MPU 28-2 that the error correction is possible, and outputs the corrected data to the host 1. On the other hand, when the MPU 28-2 receives the result that error correction is impossible, the process goes to S18 of FIG. 4.

In S18, the MPU 28-2 changes various parameters and performs the retry processing in the similar manner as in S16. The change of various parameters and the retry processing are well known, and for example, binary determination level of the Viterbi decoder 42 and characteristics of the PR channel circuit 40 (asymmetry correction characteristics and the like) are changed. Then, in the similar way as in S16, the MPU 28-2 instructs the HDC 28-1 to read the object sector.

In S20, when the error correction by ECC is possible, the ECC circuit 56 corrects errors by ECC, notifies the MPU 28-2, and outputs the corrected data to the host 1. When receiving the result that the error correction is impossible, the MPU 28-2 proceeds with the multiple retry processing in S22 and later.

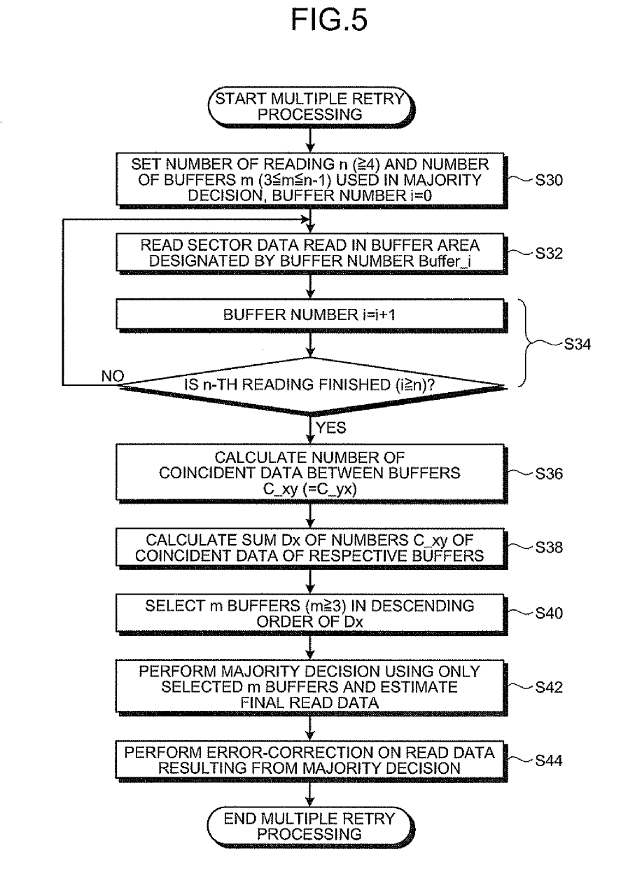

In S22, the MPU 28-2 determines the number of reading (reading number) n in the multiple retry processing and the number of buffer areas (buffer area number) m used in the majority decision, in accordance with the error range determined by the ECC circuit 56. If the error range is broad, the possibility that the error can be corrected using the majority decision is increased as the reading number is increased. Hence, the reading number n and the buffer area number m (in proportion to n) are increased. On the other hand, when the error range is narrow, the reading number n and the buffer area number m (in proportion to n) are decreased. Then, the MPU 28-2 instructs the buffer manager circuit 54 to perform the multiple retry processing, which is executed as described in FIG. 5 and later figures.

In S24, the data corrected by majority decision by the MPU 28-2 is input to the ECC circuit 56. Like in S12, S16 and S20, the ECC circuit 56 corrects the errors by ECC when the error correction by ECC is possible, notifies the MPU 28-2 that the error correction is possible, and outputs the corrected data to the host 1. When receiving the result that the error correction is impossible, the MPU 28-2 determines that it is an abnormal event and terminates the processing abnormally.

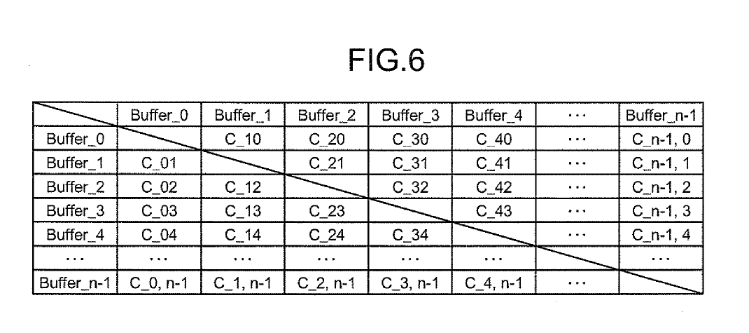

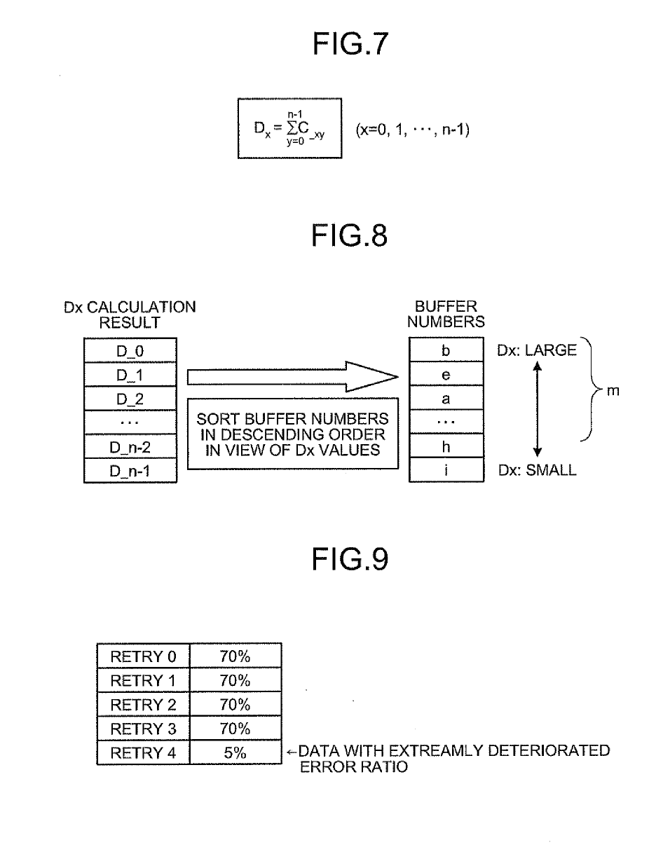

FIG. 5 is an flowchart of the multiple retry processing according to the first embodiment, FIG. 6 is a data coincidence table of FIG. 5, FIG. 7 is an explanatory diagram of summation of coincident data of FIG. 5 and FIG. 8 is a flowchart of buffer selection processing of FIG. 5.

The read retry processing of FIG. 5 is described with reference to FIGS. 6 to 8.

In S30, the number of reading n (n≧4) and the number of buffers m used in the majority decision (3≦m≦n−1) are set in S22 of FIG. 4, and the data reading is retried n-times. The buffer number i is set to the initial value “0.”

In S32, the MPU 28-2 instructs the HDC 28-1 to read the object sector, and the HDC 28-1 instructs the read channel 26 to process the signal from the reproduction head 18-1 via the preamp 34. As described with reference to FIG. 2, after the read channel 26 performs waveform-shaping at the PR channel circuit 40, the read channel 26 detects a Sync mark at the Sync mark detecting circuit 46, and operates the Viterbi decoder 42 and the RLL decoder 44. The Viterbi decoder 42 performs maximum likelihood decoding, and the RLL decoder 44 PLL decodes the decoded data. The buffer manager circuit 54 stores the RLL-decoded data (NRZ data) in a buffer area of the data buffer 30 designated by the buffer number i. Since the processing includes multiple retrying of the data reading, the MPU 28-2 instructs the buffer manager circuit 54 to store each data.

In S34, the MPU 28-2 increments the buffer number i by 1 and determines whether the buffer number i is equal to or greater than the designated reading number n. When the buffer number i is smaller than the designated reading number n, the processing goes back to S32.

In S36, when the buffer number i is equal to or greater than the designated reading number n in S34, the sector data of each reading is stored in the corresponding buffer area. The MPU 28-2 calculates a number of coincident data C_xy (C_yx) between the buffers. As illustrated in FIG. 6, data of the buffer areas 0 to n−1 are compared and the number of coincident data (bit number) C_xy (C_yx) is calculated. The calculated value is stored in the corresponding column of the table of FIG. 6.

For example, the number of coincident data C01 between the buffer area 0 (x=0) and the buffer area 1 (y=1) is calculated and stored in the table. In the similar way, the numbers of coincident data C02 to C0n−1 between the buffer area 0 (x=0) and the buffer areas 2 to n−1 (y=2 to n−1) are calculated respectively and stored in the table. This processing is also performed for the buffer area 1 (x=1) and the number of coincident data C10, C12 to C1n−1 between the buffer areas 0, 2 to n−1 (y=0, 2 to n−1) and calculated, and stored in the table respectively. In the following processing, the number of coincident data between the buffer areas 2 to n−1 (x=2 to n−1) and any other buffer areas are also calculated respectively and stored in the table.

Here, the small value of C_xy (the number of coincident data is small) indicates that there are few same signal components. That is, there are many random noises that have no correlation between each other. Conversely, large value of C_xy (the number of coincident data is large) indicates that there are many common signal components. That is, the random noise components are small.

In S38, the MPU 28-2 calculates the number of coincident data Dx of each of the buffer areas from C_xy in the table. As illustrated in FIG. 7, the number Dx of each buffer area is a sum of Cxy values. For example, the number of coincident data in the buffer area 0 is a sum of C01, C02, . . . , C0n−1 of FIG. 6.

Next, in S40, the MPU 28-2 as illustrated in FIG. 8 sorts the buffer numbers in the descending order in view of the numbers of coincident data Dx. Then, the MPU 28-2 selects buffer areas in above-described designated number of m (m≧3) from the higher sorted buffer number so as to use the buffer areas in majority decision.

In S42, the MPU 28-2 uses only the data of the selected m buffer areas, performs majority decision, and estimates final read data. That is, the majority decision is performed for the bit values at the same position in the m buffer areas to determine the bit value at the position.

In S44, the MPU 28-2 stores the estimated read data in the data buffer 30, and instructs the buffer manager circuit 54 to output the stored data to the ECC circuit 56. Accordingly, the ECC circuit 56 performs the ECC correction.

As described above, correlation (similarity) determination is performed before the majority decision, and the data with high similarity is selected so that the data with low correlation is excluded from the selection. As a result, the correction capability of the data error can be improved.

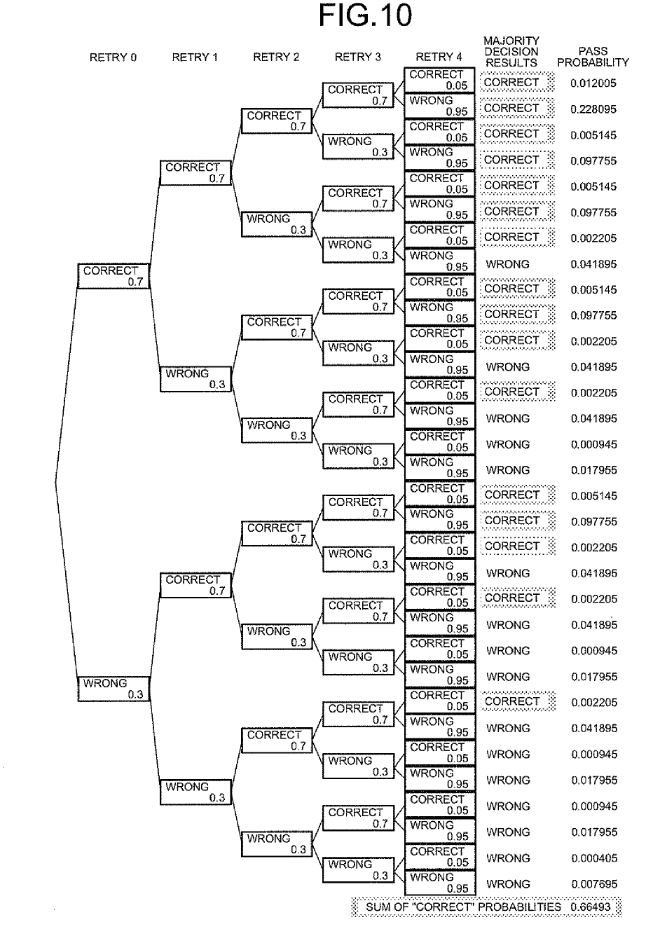

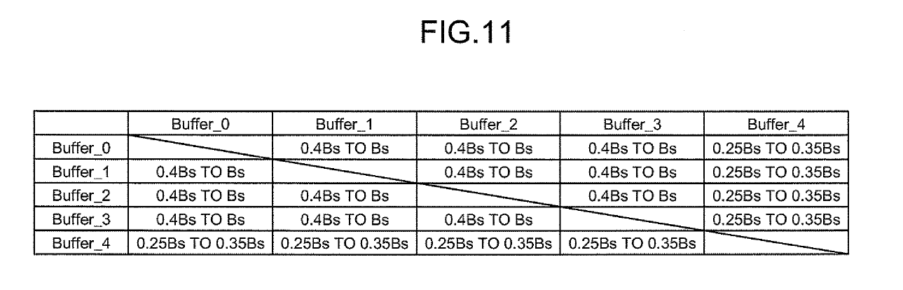

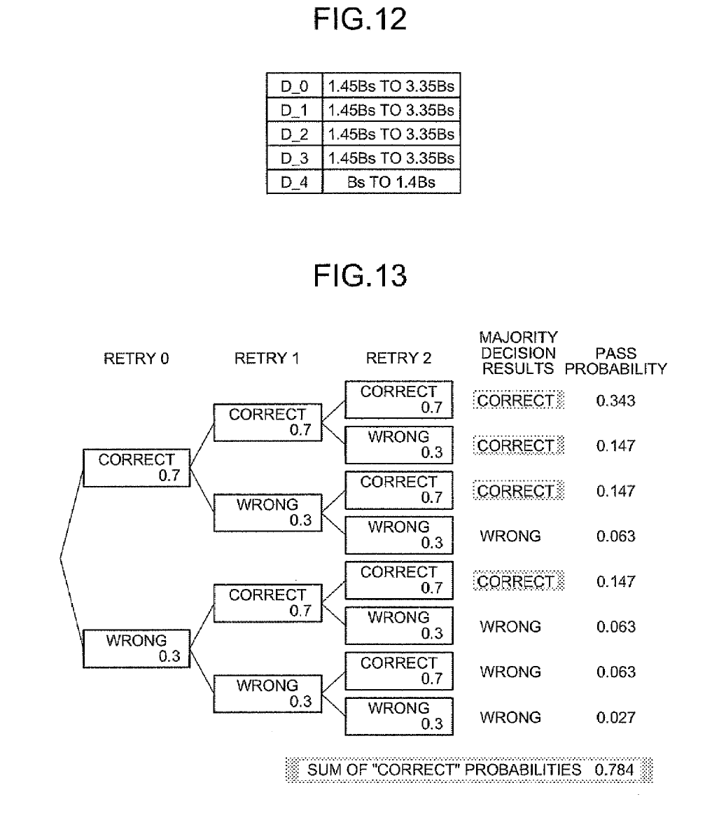

Next, description is made about examples. FIG. 9 is an explanatory diagram illustrating an example of an error ratio for 5 retries of the data reading, FIG. 10 is an explanatory diagram illustrating a probability for obtaining correct data by conventional majority logic, FIG. 11 is a data coincident table of the first embodiment, FIG. 12 an explanatory diagram illustrating the number of coincident data for each buffer, and FIG. 13 is an explanatory diagram illustrating a probability of obtaining correct data by the majority logic according to the first embodiment of FIGS. 11 and 12.

First, the data reading is retried five times and a ratio of correct data relative to recorded original data (correct data) in each try is assumed as illustrated in FIG. 9. Here, it is assumed that the data in Retry 4 (fifth retry) corresponds to an error ratio that is extremely deteriorated due to vibration or electromagnetic field.

FIG. 10 illustrates a probability of correct data when 1 bit data is subjected to conventional majority decision based on the above-mentioned condition. As illustrated in FIG. 10, since the correct data ratio of the retry 0 to 3 are 70% and the ratio of the retry 4 is 5%, the majority decision results (correct or wrong) and pass ratios calculation results in the transition of five retries are as illustrated in FIG. 10. The ratio that 1 bit data determination result is correct is indicated by a sum of correct pass probabilities, which is “0.664” as seen in FIG. 10.

On the other hand, in the first embodiment, the data read by the retries 0 to 4 are stored in the buffer areas 0 to 4 as illustrated in FIG. 11. Therefore, as described with reference to FIG. 6, the bit value C_xy which is the number coincident data between retry x and retry y is estimated to fall within the range of FIG. 11 on the above-described conditions. Here, Bs indicates the number of bits contained in one sector.

As described with reference to FIG. 7, a sum of the numbers of coincident data of respective buffers is obtained from the table C_xy of FIG. 11, which is illustrated in FIG. 12.

As seen in FIG. 12, the data read in the retry 4 (buffer 4) is ranked at the bottom in any case and excluded from the data used by the majority decision. Here, assuming that the number of buffers used for majority decision is 3 from the above, three retries 0 to 3 are selected for majority decision. Here, since the retries 0 to 3 present the same probabilities, data of the retries 0 to 2 are selected, and majority decision results (correct or wrong) and the pass probability are calculated in the similar way as in FIG. 10, which results are illustrated in FIG. 13. The ratio that 1 bit data determination result is correct is indicated by a sum of correct pass probabilities, which is “0.784” as seen in FIG. 13.

Accordingly, if it is assumed that the reading data is retried five times and the fifth retry results in extremely deteriorated error ratio, the ratio that 1 bit data determination result is correct is calculated to be “0.784,” which can prove improvement from the ratio “0.664” of the conventional majority retry processing (FIG. 10).

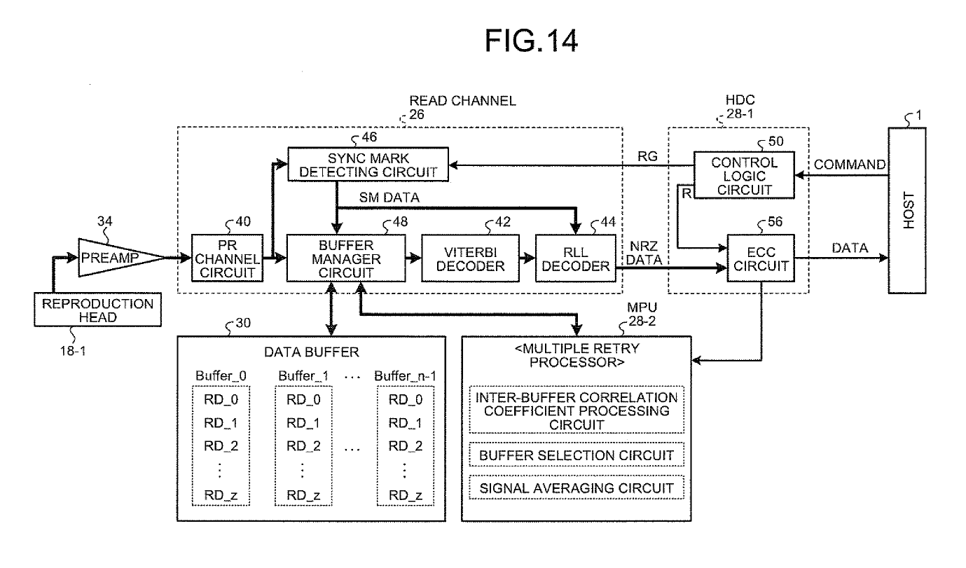

FIG. 14 is a block diagram of a read circuit according to a second embodiment, and in particular, the block diagrams illustrates the read channel 26 and a HDC/MCU 28 as in FIG. 1.

In FIG. 14, the same parts as those in FIG. 2 are denoted by the same reference numerals. In other words, a read signal from the reproduction head (read element) 18-1 of the magnetic head 18 is input to the PR channel circuit 40 of the read channel 26 via the preamp 34. The PR channel circuit 40 includes a variable gain amplifier (VGA), an asymmetry correction circuit (ASC), a continuous Time filter (CTF), an analogue/digital converter (ADC), a finite impulse response filter (FIR), an AGC circuit, and the like.

The PR channel circuit 40 first adjusts the amplitude and asymmetry of the read signal, equalizes a waveform by the control filter, A-D converts the signal and waveform-shapes the PR (partial response) signal by the FIR.

The Sync mark detecting circuit 46 detects a Sync mark SM of a predetermined pattern from an output of the PR channel circuit 40 and notifies of the Sync mark detection signal, a buffer manager circuit 48 and the RLL decoder 44.

The buffer manager circuit 48 creates buffer areas in the data buffer 30 upon the instruction from the later-described MPU 28-2, and stores reproduction signals from the PR channel circuit 40 therein. Also upon receipt of the instructions from the MPU 28-2, the buffer manager circuit 48 outputs to the Viterbi decoder 42 the reproduction signals resulting from the averaging the selected buffers by the MPU 28-2.

The Viterbi decoder 42 receives the Sync mark detection signal and performs well known maximum likelihood decoding by output from the buffer manager circuit 48. In other words, the Viterbi decoder 42 uses anteroposterior relation of the data, and selects the likelihood data frame. The RLL decoder 44 decodes RLL-coded data at the writing side and outputs resulting NRZ data to the HDC 28-1.

The HDC 28-1 includes the control logic circuit 50 configured to receive a command from the host 1 and generates a read gate RG and a read mode signal R and the ECC circuit 56 configured to perform error detection and correction with ECC (error correction codes).

The ECC circuit 56 detects and corrects error of the input data. Then, when it is determined that correction is impossible, the ECC circuit 56 notifies the MPU 28-2 that the correction is impossible. When the correction is possible, the ECC circuit 56 corrects the error and transfers the corrected data to the host 1.

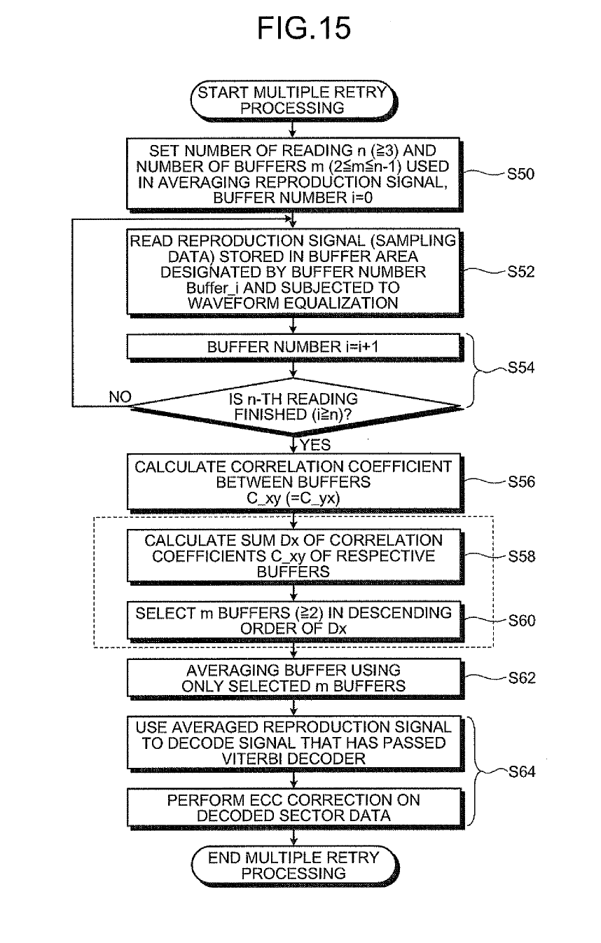

The MPU 28-2 executes the read processing including multiple retry processing described in FIG. 15, and controls the HDC 28-1 in accordance therewith. As described later, the MPU 28-2 detects the correlation between reproduction signals of buffers in a data buffer 30, selects buffers based on the correlation, and averaging data in the selected buffers.

In the second embodiment, to correct the read error, the MPU 28-2 reads the reproduction signal several times in the retry sequence, and stores the read reproduction signals in the data buffer 30. Next, the MPU 28-2 determines correlation between buffers where the reproduction signals read several times is stored, selects buffers to be used in the subsequent averaging, and uses only the selected buffers for the averaging, to create the data. The data error is corrected by the subsequent processing while the number of buffers (retry data) used is reduced by the selection.

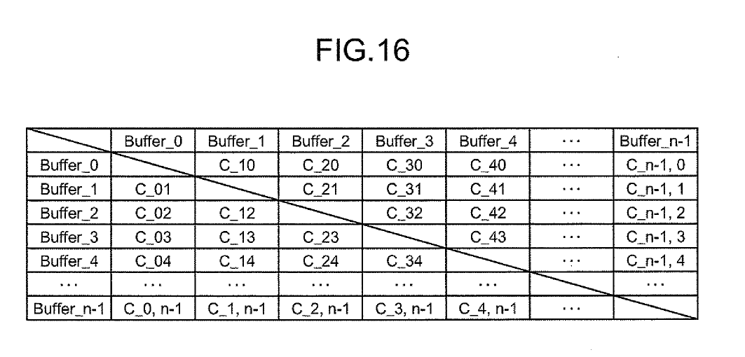

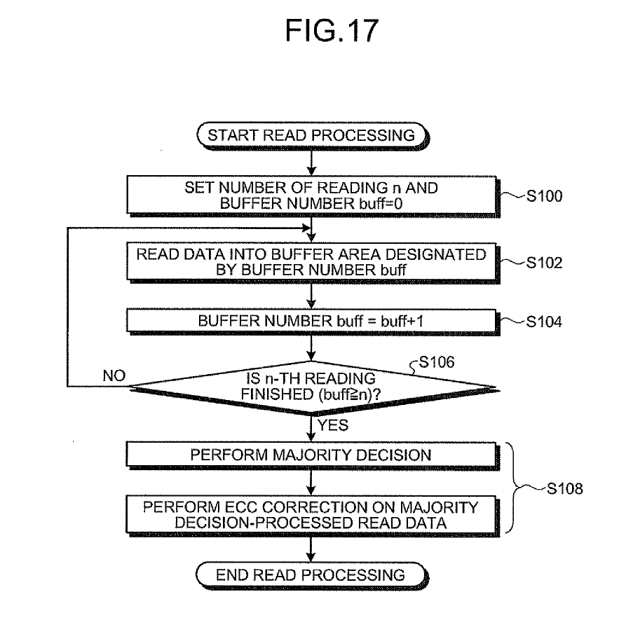

FIG. 15 is a flowchart of the multiple retry processing according to the second embodiment and FIG. 16 is a correlation coefficient table of FIG. 15. Here, the read processing is the same as that of the first embodiment illustrated in FIGS. 3 and 4, thereby the multiple retry processing of FIG. 4 is only described in the following.

The read retry processing of FIG. 15 will be described with reference to FIGS. 7, 8 and 16.

In S50, the number of reading retries n (n≧3) and the number m of buffers used for the averaging (2≦m≦n−1) are set, and the reading is retried n times in the S22 of FIG. 4. The buffer number i is set to the initial value “0.”

In S52, the MPU 28-2 instructs the HDC 28-1 to read the object sector, and the HDC 28-1 instructs the read channel 26 to perform the processing of signals from the reproduction head 18-1 via the preamplifier 34. In the read channel 26, as illustrated in FIG. 14, the PR channel circuit 40 is used to shape the waveform, and then, the Sync mark detecting circuit 46 detects a Sync mark thereby the buffer manager circuit 48 and the RLL decoder 44 are operated. The buffer manager circuit 48 stores the reproduction signal from the PR channel circuit 40 in the data buffer 30 area indicated by the buffer number i. Here, as the reading is retried several times, the MPU 28-2 instructs the buffer manager circuit 48 to store each data.

In S54, the MPU 28-2 increments the buffer number i by 1 and determines whether the buffer number i is equal to or more than the designated reading number n. When the buffer number is less than the designated reading number n, the processing goes back to S52.

In S56, when buffer number i is equal to or more than the designated read number n in S54, the reproduction signal of the sector for each of the designated reading number is stored in the corresponding buffer area. Then, the MPU 28-2 calculates data correlation coefficient C_xy (=C_yx) between the buffers. The correlation coefficient C_xy is obtained from the following expression (1).

$$C\_xy = \frac{{\sum }_{i = 0}^{n - 2} ( Buffer\_x ( i ) - \overline{Buffer\_x} ) \cdot ( Buffer\_y ( i ) - \overline{Buffer\_y} )}{\begin{matrix}\sqrt{{\sum }_{i = 0}^{n - 1} {( Buffer\_x ( i ) - \overline{Buffer\_x} )}^{2}} \\ \sqrt{{\sum }_{i = 0}^{n - 1} {( Buffer\_y ( i ) - \overline{Buffer\_y} )}^{2}}\end{matrix}} \qquad ( 1 )$$

In other words, the expression indicates to calculate distribution in the buffer areas x, y. When the data number i in each buffer is n, a difference between the i-th data Buffer_x(i) of the buffer x, and an average Buffer_x of all data inside the buffer x and a difference between the i-th data Buffer_y(i) of the buffer y and an average Buffer_y of all data inside the buffer y are multiplied, which product are prepared in the number of n and the n products are added to serve as the numerator. Then, a square of the difference between the i-th data Buffer_x (i) of the buffer x and an average Buffer_x of all data inside the buffer x is obtained n times, the n squares are added and a square root of the additional value is obtained. Besides, a square of the difference between the i-th data Buffer_y(i) of the buffer y and an average Buffer_y of all data inside the buffer y is obtained n times, the n squares are added and a square root of the additional value is obtained. These square roots are multiplied to obtain a product, which serves as the denominator.

This calculated value is stored in a corresponding column in the table of FIG. 16. For example, the correlation coefficient C01 between the buffer area 0 (x=0) and the buffer area 1 (y=1) is calculated and stored in the table. Likewise, the correlation coefficients C02 to C0n−1 between the buffer area 0 (x=0) and the buffer areas 2 to n−1 (y=2 to n−1) are calculated respectively and stored in the table. Similar calculation is performed for the buffer area 1 (x=1), the correlation coefficients C10, C12 to C1n−1 between the buffer area 1 (x=1) and the buffer areas 0, 2 to n−1 (y=0, 2 to n−1) are calculated respectively and stored in the table. This calculation is also performed for the buffer areas 2 to n−1 (x=2 to n−1) and their correlation coefficients with other buffer areas are calculated and stored in the table.

Here, C_xy is a value within a range of −1 to +1. When the value is close to +1, the correlation is positive and it has many common signal components and less random noise components. On the other hand, when the value is close to −1, the correlation is weak or the random noises, which are noises having less correlation, are increased.

In S58, the MPU 28-2 uses C_xy in the table to calculate the sum Dx of the correlation coefficients of each buffer area. As illustrated in FIG. 7, the sum Dx of correlation coefficients of each buffer area is a sum of Cxy. For example, the sum D0 of correlation coefficients of the buffer area 0 is a sum of C01, C02, . . . , C0n−1 of FIG. 16.

Then, in S60, the MPU 28-2 sorts the buffer numbers in descending order in view of sums Dx of correlation coefficients as illustrated in FIG. 8. Then, the MPU 28-2 selects an above-mentioned designated number m of buffer areas from the sorted buffer numbers (m≧2) as buffer areas used for averaging.

In S62, the MPU 28-2 only uses data of the selected m buffer areas for the averaging to estimate final reproduction signal. In other words, an average of reproduction signal values at the same position in the m buffer areas is obtained to determine a value of a reproduce signal at the position.

In S64, the MPU 28-2 stores the estimated reproduction signal value in the data buffer 30 and instructs the buffer manager circuit 54 to output it to the Viterbi decoder 42. Then, the Viterbi decoder 42 performs maximum likelihood decoding, and the RLL decoder 44 RLL-decodes the decoded data. The RLL decoded data (NRZ data) is subjected to ECC correction by the ECC circuit 56.

In this way, as the correlation (similarity) determination is performed prior to the averaging processing, a highly-similar reproduce signals are selected while low-correlative reproduce signals are eliminated to perform the averaging processing, thereby improving the data error correcting capability.

The aforementioned explanations are summarized as follows.

A data reading method for reading data from a storage module, includes: reading data from the storage module; detecting an error in the data; reading, when the error is detected, the data several times; storing each data read several times in a buffer; calculating correlation between the data stored in the buffer; selecting data stored in the buffer with strong correlation so as to exclude data with low correlation from the selection; performing majority decision on the selected data or averaging the selected data; and outputting a result of the majority decision or the averaging as read data.

The outputting further includes performing error-correction on the result of the majority decision or the averaging by an ECC circuit.

The storing includes storing in the buffer the data converted from a signal read from the storage module, and the performing majority decision includes performing majority decision on the data stored in the buffer.

The storing includes storing in the buffer a reproduction signal that is read from the storage module and waveform equalized, and the averaging includes averaging the reproduction signal stored in the buffer.

The detecting includes detecting the error in the data by the ECC circuit.

The data reading method further includes determining whether an error range of the error is larger than a predetermined range, wherein, when the range is not larger than the predetermined range, the reading reads the data.

The data reading method further includes changing, when the error is detected, a parameter corresponding to the reading data from the storage module. After the changing, the reading reads the data.

The reading the data several times includes determining a number of times of the reading the data several times in accordance with an error range of the detected error.

The reading includes reading the data from a storage medium by a head and performing waveform equalization on the read output to obtain a reproduction signal.

The reading includes decoding the reproduction signal into the data.

There are provided a storage module; a reproduction circuit configured to reproduce data read from the storage module; an error detecting circuit configured to detect an error in the data output from the reproduction circuit; a buffer configured to store the output from the reproduction circuit; and a control circuit configured to read the data several times when the error is detected, store each data read several times in the buffer, calculate correlation between the data stored in the buffer, select data stored in the buffer with strong correlation so as to exclude data with low correlation from the selection. The control circuit perform majority decision on the selected data or averaging the selected data, and output the result of the majority decision or the averaging to the error detecting circuit.

The error detecting circuit includes an ECC circuit configured to perform error-correction on the result of the majority decision or averaging.

The reproduction circuit includes a circuit configured to decode a signal read from the storage module into the data. The control circuit performs the majority decision on the decoded data stored in the buffer.

The reproduction circuit includes a circuit configured to perform waveform equalization on a signal read from the storage module. The control circuit averages the waveform-equalized reproduction signal stored in the buffer.

The control circuit starts reading the data several times when the ECC circuit detects the error in the read data.

The control circuit determines whether an error range of the error is larger than a predetermined range, and when the error range is not larger than the predetermined range, the control circuit reads the data.

When the error is detected, the control circuit changes a parameter corresponding to reading the data by the reproduction circuit, and reads the data after changing the parameter.

The control circuit determines a number of times of reading the data several times in accordance with the range of the detected error.

The storage module includes a storage medium and a head configured to read the data from the storage medium. The reproduction circuit includes a circuit configured to perform waveform equalization on the read output to output to obtain the reproduction signal.

The reproduction circuit further includes a decoding circuit configured to decode the reproduction signal into the data.

The above-described embodiment has been described by way of an example where magnetic disk device as the storage device. However, the storage device can be applied to other medium such as a thermal assist disk device, an optical disk device, and the like.

In addition, the storage device and the method is also applicable to multilevel recorded memory (for example, flash memory and the like) as in such a memory, the error ratio varies affected by the electromagnetic field.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data reading method of a storage device for reading data from a storage module, comprising:
reading data from the storage module;
detecting an error in the data;
reading, when the error is detected, the data several times;
storing each data read several times in a buffer;
calculating correlation between the data stored in the buffer;
selecting data stored in the buffer with strong correlation so as to exclude data with low correlation from the selection;
performing majority decision on the selected data or averaging the selected data; and
outputting a result of the majority decision or the averaging as read data.

2. The data reading method of claim 1, wherein the outputting further includes performing error-correction on the result of the majority decision or the averaging by an ECC circuit.

3. The data reading method of claim 1, wherein
the storing includes storing in the buffer the data converted from a signal read from the storage module, and
the performing majority decision includes performing majority decision on the data stored in the buffer.

4. The data reading method of claim 1, wherein
the storing includes storing in the buffer a reproduction signal that is read from the storage module and waveform equalized, and
the averaging includes averaging the reproduction signal stored in the buffer.

5. The data reading method of claim 2, wherein the detecting includes detecting the error in the data by the ECC circuit.

6. The data reading method of claim 1, further comprising determining whether an error range of the error is larger than a predetermined range, wherein, when the range is not larger than the predetermined range, the reading reads the data.

7. The data reading method of claim 1, further comprising changing, when the error is detected, a parameter corresponding to the reading data from the storage module, wherein, after the changing, the reading reads the data.

8. The data reading method of claim 1, wherein the reading the data several times includes determining a number of times of the reading the data several times in accordance with an error range of the detected error.

9. The data reading method of claim 1, wherein the reading includes reading the data from a storage medium by a head and performing waveform equalization on the read output to obtain a reproduction signal.

10. The data reading method of claim 9, wherein the reading includes decoding the reproduction signal into the data.

11. A storage device comprising: a storage module;
a reproduction circuit configured to reproduce data read from the storage module;
an error detecting circuit configured to detect an error in the data output from the reproduction circuit;
a buffer configured to store the output from the reproduction circuit; and
a control circuit configured to read the data several times when the error is detected, store each data read several times in the buffer, calculate correlation between the data stored in the buffer, select data stored in the buffer with strong correlation so as to exclude data with low correlation from the selection, wherein
the control circuit perform majority decision on the selected data or averaging the selected data, and output the result of the majority decision or the averaging to the error detecting circuit.

12. The storage device of claim 11, wherein the error detecting circuit includes an ECC circuit configured to perform error-correction on the result of the majority decision or averaging.

13. The storage device of claim 11, wherein
the reproduction circuit includes a circuit configured to decode a signal read from the storage module into the data, and
the control circuit performs the majority decision on the decoded data stored in the buffer.

14. The storage device of claim 11, wherein
the reproduction circuit includes a circuit configured to perform waveform equalization on a signal read from the storage module, and
the control circuit averages the waveform-equalized reproduction signal stored in the buffer.

15. The storage device of claim 12, wherein the control circuit starts reading the data several times when the ECC circuit detects the error in the read data.

16. The storage device of claim 11, wherein the control circuit determines whether an error range of the error is larger than a predetermined range, and when the error range is not larger than the predetermined range, the control circuit reads the data.

17. The storage device of claim 11, wherein, when the error is detected, the control circuit changes a parameter corresponding to reading the data by the reproduction circuit, and reads the data after changing the parameter.

18. The storage device of claim 11, wherein the control circuit determines a number of times of reading the data several times in accordance with the range of the detected error.

19. The storage device of claim 11, wherein
the storage module includes a storage medium and a head configured to read the data from the storage medium, and
the reproduction circuit includes a circuit configured to perform waveform equalization on the read output to output to obtain the reproduction signal.

20. The storage device of claim 19, wherein the reproduction circuit further includes a decoding circuit configured to decode the reproduction signal into the data.
